(19) United States
(12) Patent Application Publication
(10) Pub. No.: US 2026/0232406 A1
(43) Pub. Date: Aug. 13, 2026

(54) An Instrument for Setting a Dental Bracket

(71) Applicant: Inna Gorbushina, Geldern (DE)

(72) Inventor: Inna Gorbushina, Geldern (DE)

(21) Appl. No.: 19/148,026

(22) PCT Filed: Oct. 26, 2023
(86) PCT No.: PCT/EP2023/080020

§ 371 Date: Jul. 15, 2025

(30) Foreign Application Priority Data
Jan. 15, 2023 (DE) 20 2023 100 178.5

(51) Int. Cl. A61C 7/14

(52) U.S. Cl. CPC A61C 7/146

(57) ABSTRACT

An instrument (10) for setting a dental bracket (18) is in a releasable, form-fitting connection during a setting process with structures of the bracket (18) to be placed. The instrument (10) comprises a handle part (12) and a head part (14) designed to hold the bracket (18) to be placed. The form-fitting connection is brought about at least partially by at least one holding element (50) provided on the head part (14), which is designed to hold the bracket (18) by engagement into a bracket slot (22) of the bracket (18) to be placed. An integrated positioning cross laser can generate linear markings (28, 30) in an imaginary extension on the left and right (30) of the bracket slot (22) and orthogonally thereto upwards and downwards (28).

The present invention relates to an instrument for setting a dental bracket according to the preamble of patent claim 1.

Dental brackets are commonly employed in orthodontic treatment to correct misalignment of teeth using fixed dental braces.

In conventional orthodontic treatment, brackets are typically attached to the front surface of the teeth using adhesive. These brackets can be made of various materials, such as metal, plastic, or ceramic. Once the brackets are securely bonded to the teeth, they are interconnected using a wire known as an archwire. The archwire applies a desired amount of gentle pressure, also known as preload, to gradually move the teeth into their desired positions. The combination of brackets and archwire forms an essential part of the orthodontic treatment process, allowing for controlled and precise tooth movement.

For this purpose, the wire is inserted into a recess in the brackets, the so-called bracket slot, and fixed there.

In conventional systems, the wire is fixed in the bracket slot using rubber bands or with short metal ligatures.

In so-called self-ligating systems, the wire is held using special closure mechanisms integrated into the brackets without the need for a rubber band or other ligatures.

The precise placement of brackets during adhesive bonding is an indispensable aspect of orthodontic practice, crucial for ensuring the quality of orthodontic supply.

Conventionally, the brackets, after the tooth fronts have been pre-etched in order to improve the adhesion of the adhesive, are laterally encompassed by means of a special spring-loaded forceps or tweezers and then placed on the tooth front by the handler with application of an adhesive—often a UV-curing adhesive.

Before curing of the adhesive, positional corrections are still possible to a certain extent.

To ensure consistent and precise alignment via the row of teeth during bracket placement, there are specialized tools called “positionierer” (positioner) that can be used. Alternatively, gauges can be used for fine adjustments during the adhesive bonding process. However, it's important to note that using these gauges requires a high level of dexterity and fine motor skills from the orthodontic practitioner.

The conventional method of bracket positioning using positionierers has limitations as it only considers the height position and overlooks other important degrees of freedom. Besides the lateral position (centering the bracket on the tooth), there is also the potential for angular rotation around an axis. Mistakes in these adjustments may necessitate complex and time-consuming corrective measures for the patient. Removing a freshly bonded bracket poses risks to the tooth structure, such as fracturing or damage, due to the applied force required during removal.

In addition, prolonged use of the specialized spring-loaded tweezers carries inherent medical risks for the orthodontic practitioner. This includes the potential for excessive strain and inflammation of the tendons in the hand, particularly in the thumb-supporting apparatus. Such orthopedic overloading can result in chronic arthritic pain, posing a long-term risk that may ultimately lead to professional disability.

Apart from vestibular brackets, lingual brackets are also frequently utilized in orthodontic treatment. However, bonding lingual brackets directly to the lingual surfaces of a patient's teeth can be a time-consuming and labor-intensive process. This is primarily due to the limited accessibility and suboptimal visibility conditions of the lingual surfaces, as well as the anatomical variations present. Consequently, orthodontic treatment involving lingual brackets demands a high level of skill and expertise from the orthodontist.

The objective of the present invention is to introduce an instrument that enables rapid and highly precise positioning of brackets (whether vestibular or lingual) using both direct and indirect adhesive techniques. This instrument allows for precise alignment in all degrees of freedom, ensuring optimal placement of brackets during orthodontic treatment.

To address the previously mentioned issue, a proposed solution is an instrument designed for the placement of dental brackets. This instrument incorporates a releasable and secure connection with the bracket's structures during the placement process. It consists of a handle part and a head part specifically designed to securely hold the bracket that is to be positioned.

According to an aspect of the invention, the instrument provides a form-fitting connection, which is achieved through the presence of one or more holding elements on the head part. These holding elements are specifically designed to securely engage with a bracket slot of the bracket that is being positioned, thereby ensuring a reliable and precise attachment.

Unlike conventional clamps or tweezers that encompass the bracket itself, the proposed instrument functions by gripping the bracket slot or bracket gap specifically designed to accommodate the wire. This unique approach allows for temporary fixation of the bracket, enabling precise and reproducible positioning on the tooth surfaces. The bracket can be aligned within a designated adhesive bed, whereupon the adhesive cures, potentially utilizing UV irradiation to expedite the process, as commonly practiced.

The utilization of the bracket slot offers several advantages. Firstly, it eliminates the need for a continuous mechanical holding force to be exerted on the instrument, unlike with clamps or tweezers. Consequently, this alleviates potential strain on the tendons, muscles, and joints of the orthodontic practitioner, minimizing the risk of long-term overloading and associated musculoskeletal complications. By capitalizing on the bracket slot's design, the instrument achieves secure fixation of the bracket during the positioning process, ensuring efficient and ergonomic orthodontic procedures.

Furthermore, the form-fitting fixation within the bracket slot allows for significantly enhanced precision in aligning the bracket both in terms of position and angular orientation. This precise alignment is further augmented by the incorporation of a cross laser in a preferred embodiment of the instrument. The integrated cross laser assists in visually guiding the orthodontic practitioner, facilitating even more accurate bracket placement and alignment. By leveraging this combination of form-fitting fixation and cross laser technology, the instrument empowers practitioners to achieve optimal positioning of the brackets, thereby enhancing treatment outcomes.

The temporary form-fitting connection between the bracket and the instrument can be achieved through precisely designed structures that fit into the bracket slot with a slight gap or a minimal oversize. This precise dimensional accuracy allows for a secure yet releasable clamping effect within the bracket slot. By carefully engineering these components, the instrument establishes a reliable connection with the bracket, ensuring stability during the positioning process while still allowing for easy removal when necessary.

To ensure the instrument's versatility across various bracket types with different bracket slot geometries, an alternative approach involves the orthodontic practitioner using an additional temporary holding substance, such as wax, in conjunction with the instrument. In this case, the structure that engages with the bracket slot can be designed to be slimmer and adaptable to different solder dimensions. The holding substance, acting as an intermediary, facilitates a secure form-fitting connection between the instrument and the bracket, allowing for flexibility in accommodating various bracket designs, which can be compensated for by the use of a temporary holding substance like wax.

Additionally, the fixation of the bracket can also be accomplished using additional elements on the instrument that apply lateral pressure against specific structures of the bracket. These supplementary elements serve to provide an additional level of fixation and stability for the bracket, further securing its position during the orthodontic procedure.

In a preferred embodiment, the head part of the instrument features a web on its end side. This web is specifically designed to engage with the bracket slot, as previously described. Depending on the specific requirements, the web can engage with varying degrees of clearance within the bracket slot. In cases where a greater clearance is desired, it is recommended to utilize a holding substance such as wax or alternative retaining structures to ensure a secure and reliable connection between the instrument and the bracket. This approach provides flexibility in accommodating different bracket slot dimensions and ensures effective bracket positioning during orthodontic procedures.

In order to achieve precise centering of the bracket within the instrument, the distance between these limiting legs is preferably calibrated to match the typical width of the bracket. When the distance approximately corresponds to the bracket width (with a slight allowance for a slightly larger distance), the bracket can be accurately centered within the instrument.

Depending on the specific geometry of the brackets, they may feature an additional slot that is oriented transversely to the bracket slot. This additional slot allows for engagement with an appropriately adapted instrument according to the present invention. The instrument is designed to effectively engage with both the bracket slot and the transverse slot, providing versatile compatibility with various bracket designs.

In an alternative embodiment, instead of the H-shaped web structure, the web within the head part of the instrument can be penetrated approximately at the center or at the end by an approximately transversely arranged limb. This configuration results in the formation of an approximately plus-shaped structure (when the limb is positioned approximately centrally) or a T-shaped structure (when the limb is located at the end). These variations allow for different options in engaging with the bracket slot and provide additional flexibility in accommodating various bracket designs, for example for self-lighting brackets with built-in mechanism

In another embodiment, not explicitly depicted in the figures, the transversely arranged limbs are designed to be primarily movable in the direction of the web. This allows for the application of a compressive force on both limbs, enabling additional fixation of the bracket being placed. By exerting this compression force, the instrument ensures a secure and stable attachment of the bracket during the orthodontic procedure.

In one embodiment, the web within the head part of the instrument can be bounded at its two ends by two approximately transversely arranged limbs. This configuration gives rise to an H-shaped structure of the web. Additionally, the web may extend further on one or both sides beyond the limbs, allowing for increased versatility and adaptability in engaging with the bracket slot.

This can be achieved by incorporating linearly movable limbs, allowing for straight-forward compression of the bracket. Alternatively, the limbs can be designed to pivot, functioning similar to a pincer or tweezers. In this case, the spacing between the limbs needs to be adjusted to match the width of the brackets being applied. By adapting the spacing accordingly, the instrument can effectively grip and secure the bracket, ensuring precise positioning and fixation during orthodontic procedures.

The application of the compression force, directed towards the center line of the instrument, can be achieved through a spring-loaded mechanism. This mechanism can be designed to exert a constant and continuous compression force, or it can be made releasable by the orthodontic practitioner. In the releasable configuration, the compression force can be controlled by the handler, typically through the actuation of a button, lever, or similar mechanism. This enables the opening of the pincer or tweezer brackets, allowing for easy insertion and removal of the bracket.

To minimize the risk of orthopedic degenerative issues for the handler, it is preferable to avoid the need for the handler to continuously apply force to hold the bracket. Instead, the emphasis is placed on a design that requires the handler to apply force only when releasing the bracket. This approach reduces the strain on the handler's hand and minimizes the potential for long-term musculoskeletal issues.

Indeed, the pincer or tweezers fixture can be used in conjunction with the form-fit holding of the bracket, which secures the bracket in its desired position. Additionally, it can also be utilized alongside a wax fixture if necessary.

In a particular embodiment, one or two centering teeth can be positioned above and/or below the web, spaced apart from it along the longitudinal extension. These teeth are designed to engage with recess-like structures present in the brackets. By doing so, they facilitate centering of the instrument in relation to the brackets and provide an additional means of fixation if required.

In the case of an approximately H-shaped web structure, wherein two centering teeth are positioned between the limbs of the “H,” it can be considered to have at least one gap dimensioned to accommodate the presence of a bracket closure. Many bracket types exhibit a locking lever or another closure element that protrudes somewhat off-center, either on the top or bottom, left or right side. The instrument must have a corresponding recess at this location, which is released by the centering teeth, allowing the instrument to accommodate such brackets.

In the preferred embodiment, the handle part of the instrument maintains a straight extension of the holding element that engages in the bracket slot. As a result, the entire instrument extends orthogonally to the placement of the bracket on the tooth surface. This design feature offers significant advantages over conventional tweezers, as it allows for improved and more precise positioning during orthodontic procedures.

For the in-situ setting of lingual brackets, an alternative design option is to incorporate an angled handle part. In this case, the handle part is preferably angled at approximately 90 degrees, providing a convenient and ergonomic grip for the orthodontic practitioner. This angled configuration facilitates improved access and maneuverability when placing lingual brackets, which are positioned on the inner side of the teeth.

To further enhance the positioning process, it is advantageous for the instrument to include an integrated positioning laser in a preferred embodiment. The integration of a positioning laser provides a visual aid for the orthodontic practitioner, aiding in the precise placement of brackets. The laser emits a focused beam or projection, which assists in aligning the instrument accurately on the tooth surface and ensures optimal bracket positioning.

In the preferred embodiment, the positioning laser is designed as a cross laser. When the bracket is applied to the tooth front, the cross laser generates projected linear markings. These markings extend to the right and left of the bracket slot, as well as upwards and downwards in an orthogonal direction. The use of a cross laser enables the orthodontic practitioner to visually align the bracket precisely within the desired position.

The laser lines projected on the right and left of the bracket slot serve the purpose of enabling precise adjustment of the bracket position's height relative to previously placed brackets. By visually aligning the bracket's position along these laser lines, orthodontic practitioners can ensure that the bracket is positioned at the desired height, maintaining consistency and proper alignment throughout the treatment.

Moreover, the precise alignment of the bracket slot angle facilitated by the laser lines is crucial for creating the desired treatment arc and ensuring friction-free wire guidance.

Furthermore, the laser lines projected upwards and downwards by the cross laser allow for the central alignment of the bracket on the specific tooth, while considering the positions of the adjacent teeth in the upper and lower rows. By utilizing these laser beams, any angular positioning errors can be easily identified and corrected. This comprehensive alignment assessment ensures that the bracket is precisely positioned at the center of the tooth, accounting for the surrounding teeth in the dental arch. The laser lines serve as a visual guide, enabling orthodontic practitioners to detect and rectify any angular positioning discrepancies, ensuring accurate bracket placement and facilitating the achievement of optimal treatment outcomes.

In a preferred embodiment, the instrument includes a transition part that is specifically designed to accommodate the cross laser beams. The transition part features at least four recesses strategically positioned to allow the laser beams to exit and project the necessary cross-shaped markings. These recesses are carefully placed to ensure optimal visibility and alignment of the laser lines during bracket placement.

In this context, the transition part is preferably designed to taper conically towards the head part.

The cross laser is positioned at the head-side end of the handle part in a preferred configuration. It incorporates an optical system that is specifically designed to enable the four beams of the cross laser to exit through the recesses present in the transition part. This carefully engineered optical system ensures that the laser beams are effectively projected and aligned with precision, creating the desired cross-shaped markings for accurate bracket placement.

In addition, the cross laser integrated into the instrument can emit light in various colors: blue, red, or green. It is worth noting that non-red light colors generally provide better contrast against the gingival structures, enhancing visibility and facilitating precise positioning of the brackets. Moreover, the orthogonal directions of the cross laser can be differentiated by employing different light colors, further aiding in the accurate alignment and orientation of the brackets on the tooth surfaces.

In a preferred configuration, the head part of the instrument, with or without the transition part, can be designed to be interchangeable, enabling convenient customization of the instrument to accommodate various types of brackets. This interchange-ability feature enhances the versatility and adaptability of the instrument, facilitating its use across different orthodontic procedures and bracket systems. By easily exchanging the head part, orthodontic practitioners can seamlessly transition between different bracket types, ensuring optimal functionality and compatibility with specific treatment requirements.

Moreover, this design allows for straightforward sterilization of the head part, ensuring optimal hygiene during orthodontic procedures. It eliminates the need for sterilizing the entire instrument, including the handle part and the integrated cross laser, as they are not directly exposed to the treatment area. By focusing the sterilization process on the easily detachable and sterilizable head part, the instrument can be efficiently maintained in a sterile condition while minimizing potential damage or disruption to the delicate components of the cross laser and its power supply. This streamlined sterilization approach enhances infection control protocols and reduces the risk of cross-contamination, ensuring the highest standard of patient care in orthodontic practices.

Additionally, the power supply for the cross laser can be conveniently achieved by integrating batteries or rechargeable accumulators into the handle part of the instrument. This eliminates the need for a wired power supply connected to the treatment chair unit, which is commonly used for other dental instruments. Given the relatively low power consumption of laser diodes in positioning lasers, using integrated batteries or accumulators offers a practical and efficient solution. This self-contained power supply system ensures greater flexibility and ease of use during orthodontic procedures, allowing for unrestricted movement and positioning of the instrument without the constraints of wired connections.

The activation of the positioning or cross laser is achieved by using a switch integrated into the instrument, which can be designed as a rotary switch or any other suitable type of switch. The laser power and focusing parameters are carefully chosen to ensure eye safety, aiming to achieve an approximate laser protection class of 1 or 2. This ensures that the emitted laser beams pose minimal risk to the eyes of both the orthodontist and the patient during the bracket placement process. Safety precautions and adherence to laser protection guidelines are of utmost importance to protect the well-being of all individuals involved in the orthodontic treatment.

The invention is explained in more detail below with reference to the examples shown in drawings.

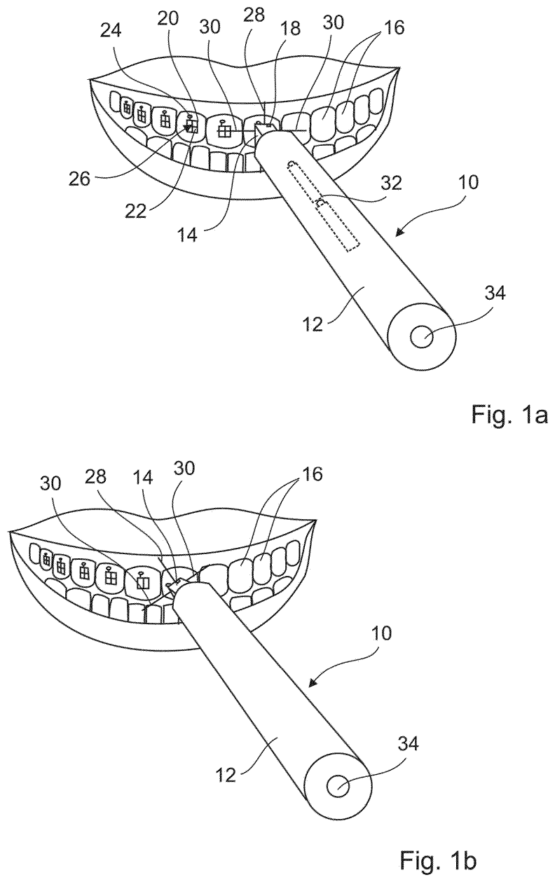

FIG. 1a shows a schematic representation of an instrument according to the invention when positioning a dental bracket;

FIG. 1b shows a schematic representation similar to FIG. 1a, but a situation with a bracket attached obliquely/at an angle;

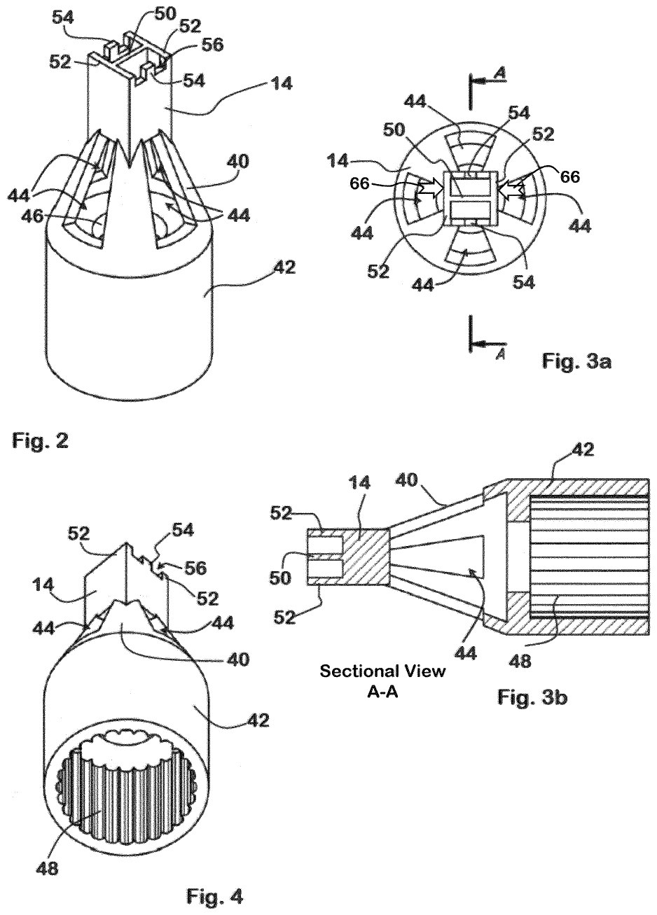

FIG. 2 is a perspective view of a head of an instrument according to the invention including a transition part as a top view;

FIG. 3a shows a plan view of the head according to FIG. 2;

FIG. 3b shows a sectional view along the line A-A of FIG. 3a;

FIG. 4 is a perspective view of the head of FIG. 2 as a bottom view;

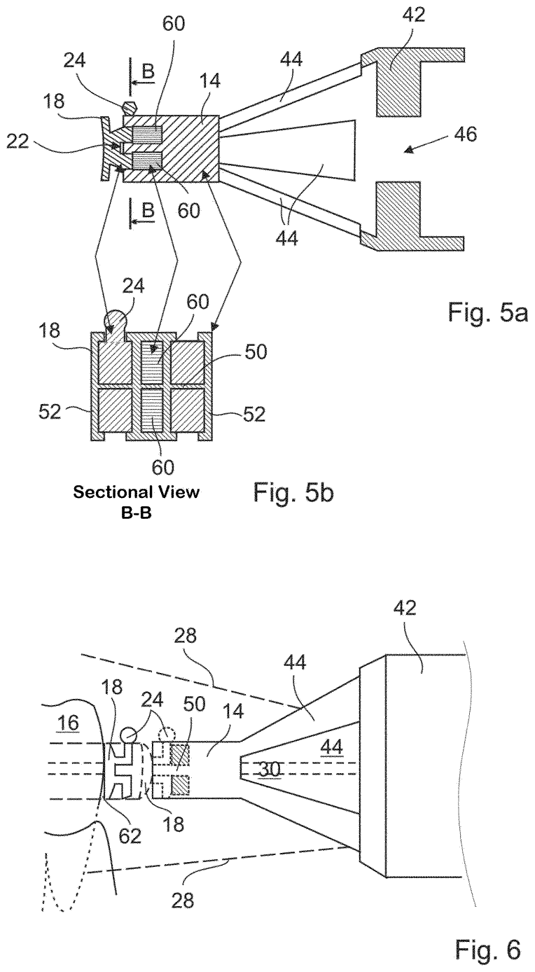

FIG. 5a shows a schematic sectional view through an instrument according to the invention with an attached bracket temporarily fixed by means of wax;

FIG. 5b shows a schematic sectional view along the line B-B of FIG. 5a;

FIG. 6 shows a schematic sectional view through an instrument according to the invention for illustrating the application and detachment process for the bracket; and

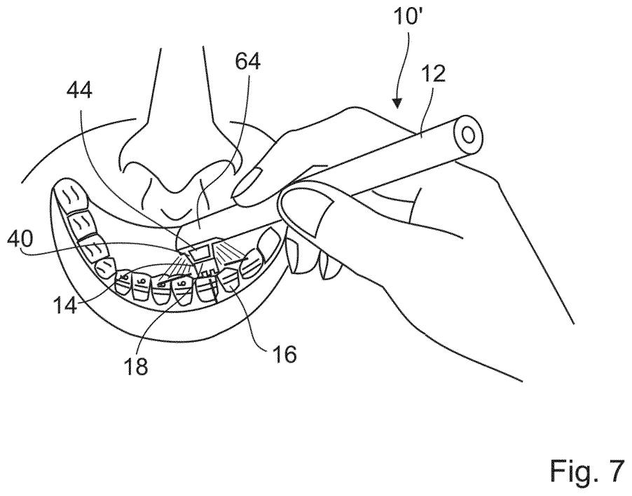

FIG. 7 shows a schematic illustration of an alternative embodiment of an instrument according to the invention, particularly suitable for setting lingual brackets.

FIG. 1a shows a highly schematic representation of an instrument 10 according to the invention when a dental bracket 18 to be placed is applied to a tooth front of a tooth of a row of teeth, wherein the teeth are marked with 16 and a handle part with 12.

It should be emphasized that the schematically illustrated bracket 18 is merely an example and the invention is intended to be suitable for a multiplicity of bracket types available on the market (both for vestibular and for lingual application), optionally with correspondingly adapted head of the instrument, wherein the essential prerequisite is that the bracket to be set has a horizontal depression for receiving the wire, the so-called bracket slot 22.

In FIG. 1a, in addition, in the bracket 20 adjacent to the bracket 18 to be replaced, it is also schematically indicated that the bracket 20 has a bracket closure 24 designed as a small lever arranged at the top left. In addition, it is indicated that the bracket 20 can have an additional vertical slot 26 centrally; this varies as mentioned between the different bracket types.

The bracket 18 to be set is held in a form-fitting manner by the head 14 of the instrument, optionally using a holding mediator such as wax (see below) and placed on the pretreated (primed) tooth front provided with an adhesive, and the adhesive is then brought to cure.

Alternatively, particularly preferably in the case of lingual brackets, the instrument 10 can be used in the context of an indirect adhesive technique by means of a jaw model, as described above or known in the prior art.

A cross laser (46 in FIG. 5A), which can be supplied by batteries 32 or batteries integrated in the handle part 12 and can be switched on or off by the handler via a switch 34, facilitates exact positioning by virtue of vertical line 28 being produced upwards and downwards (only the line facing upwards shown in FIG. 1a) and vertical lines 30 to the right and left, wherein preferably green or blue is selected as the laser color in order to lift more clearly from the gum color.

The bracket 18 to be set can be set exactly at the height of the already set adjacent bracket 20 by means of the horizontal laser lines 30. Furthermore, the angle can be controlled very accurately (cf. the incorrect positioning in FIG. 1b).

By means of the vertical laser lines 28, the central alignment of the bracket 18 with respect to the relevant tooth front 16 or with respect to the teeth of the underlying or overlying row of teeth can be ensured; furthermore, angle control is also possible.

This exact positioning is possible in that the bracket 18 in the head 14 of the instrument 10 can be temporarily fixed in a defined position in a form-fitting (but detachable) manner, so that the current position of the currently extending handle part 12 corresponds to the cross laser with the position of the bracket 18 to be set.

FIGS. 2, 3a, 3b and 4 show a corresponding head part 14 of an instrument which is suitable for a plurality of common brackets.

The head part 14 opens into a rectangular region which has different webs and projections which are adapted to the dimensions and structures of the brackets to be set, and are to be understood here only by way of example.

A web 50 engages in the bracket slot 22 of the bracket 18 to be placed. The web 50 can either engage in a form-fitting manner in the bracket slot 22, or the web 50 can have an undersize in order to be able to set a plurality of different bracket types having a different slot width by means of the head 14, and the bracket can then additionally be temporarily fixed with a holding agent such as wax.

Two limbs 52 extend transversely to the web 50 at the end, so that the head in this example has an H-shaped contour.

In order to adapt to other bracket types, however, a +-contour or a T-shaped contour (not shown) is also conceivable, for example.

Furthermore, two centering teeth 54 are provided centrally in the intermediate spaces between the legs 52. A gap 56 in each case remains laterally from the centering teeth to the limbs 52. This gap is designed to receive the respective bracket closure 24 (if there is at which corner it can also always be arranged), and thus brings about an additional stabilization.

A conical transition part 40, which has four recesses or slots 44 for the exit of the laser beams of a cross laser light source 46 (not shown in detail), is provided towards the handle part 12 (not shown in FIG. 2 to FIG. 4). The cross laser light source 46 is based on one or more laser light-emitting diodes with corresponding cross beam optics, as is basically known in the prior art.

In the following part to the transition part 40 in the direction of the handle 12, a connection piece 42 is provided, which on the inside has a rotationally fixing tooth structure 48 which can interact with a corresponding structure of the handle part (not shown). The tooth structure preferably has an angle coding structure (not shown) (e.g., a thickened rib), which causes the head to be placed on the handle part only at 90° or 180° angular distances or only in one single angular position at all. This is advantageous if the cross laser light source 46 is accommodated in the handle part 12 in order to ensure the correct alignment of the laser. This design makes it possible to pull the head part 14 away from the handle part 12 and to sterilize it separately. Furthermore, the head part 14 can be simply exchanged for different types of head parts for different bracket types.

In FIG. 3a two arrows 66 symbolize the direction of application of a possible additional compression force applicable by the legs 52 by an optional spring-loaded mechanism (not shown) to further fixate the bracket to be mounted in pincer or tweezer-like manner during bracket application. In this optional embodiment the legs 52 should be either be somewhat spaced position from the web 50 or should have an integrated slit to let the web 50 pass, so the legs are enabled to move a certain distance in the directions of the arrows 66, whereby such details—as well as the spring load mechanism—are not shown.

FIGS. 5a and 5b show schematically how the bracket 18 to be set can be temporarily fixed with wax (hatched regions 60).

It can also be seen in FIG. 5b how the bracket closure 24 is received by the gap 56. FIG. 6 schematically shows the setting process of the bracket at a stage shortly before the application of the bracket 18 to the tooth front 16 (dashed representations) and after the setting (non-dashed illustration), wherein the adhesive layer is denoted by 62.

The rays 28 and 30 of the cross laser can also be seen in FIG. 6.

FIG. 7 shows an alternative embodiment of an instrument 10′ according to the invention, in which the head part 14 (and thus also the web 50 engaging in the bracket slot) is angled by approximately 90° with respect to the handle part 12 in an angular transition region 64, so that an in-situ application of lingual brackets 18 is also possible, as illustrated in FIG. 7.

In this embodiment, the transition part 40 extends with the integrated cross laser 46 and the outlet slots 44 out of a side surface of the handle part 12.

Of course, other angles than 0° or 90° between the head part 14 and the handle part 12 are also conceivable; if appropriate, the angle can also be designed to be adjustable by means of an adjustable and fixable joint (not shown).

### LIST OF REFERENCE SIGNS

10, 10′ Instrument
12 Grip part
14 Head part
16 Tooth fronts
18 Dental Bracket to be applied
20 adjacent brackets
22 Bracket slot
24 Bracket closure
26 Vertical bracket slot
28 Cross laser beams at the top/bottom
30 Cross laser beams right/left
32 Batteries
34 Switch
40 Transition part
42 Attachment piece
44 Laser exit slots
46 Cross laser light source
50 Bar
52 Leg
54 Centering teeth
56 Gap
60 Fixing wax
62 Adhesive
64 Angular transition region
66 Arrows

1. An instrument (10) for setting a dental bracket (18), wherein the instrument (10) is in a releasable, form-fitting connection during the setting process with structures of the bracket (18) to be placed, wherein the instrument (10) further comprises a handle part (12) and a head part (14) designed to hold the bracket (18) to be placed,
wherein the form-fitting connection is brought about at least partially by at least one holding element (50) provided on the head part (14), which is designed to hold the bracket (18) by engagement into a bracket slot (22) of the bracket (18) to be placed.

2. The Instrument (10) according to claim 1, wherein the head part (14) has a web (50) which is designed to engage in the bracket slot (22) on the end side.

3. The instrument (10) according to claim 2, wherein the web (50) is delimited at its two ends by two approximately transversely arranged limbs (52), as a result of which an approximately H-shaped web structure is formed, wherein the web (50) can continue on one or both sides in connection with the limbs (52).

4. The instrument (10) according to claim 3, wherein the transversely arranged limbs (52) are movable mainly in a direction of the web (50) and a compression force can be applied to both limbs to further fixate the bracket (18) to be placed.

5. The instrument (10) according to claim 2 wherein the web (50) is preferably penetrated approximately centrally or at the end by an approximately transversely arranged limb, as a result of which an approximately plus-shaped or a T-shaped web structure is formed.

6. The instrument (10) according to claim 1, wherein above and/or below the web (50), relative to the longitudinal extension of the web (50), approximately centrally on one or two centering teeth (54) spaced apart from the web (50) are arranged.

7. The instrument (10) according to claim 6, wherein an approximately H-shaped web structure with a total of two centering teeth (54) is provided between the limbs of the “H”, wherein at least one of the gaps (56) is dimensioned to the side of the centering teeth (54) for receiving a bracket closure (24).

8. The instrument (10) according to claim 1, wherein the grip part (12) extends in a straight extension of the holding element (50) or is angled by approximately 90° with respect to the direction of the holding element.

9. The instrument (10) according to claim 1, wherein it has an integrated positioning laser (46).

10. The instrument (10) according to claim 9, wherein the positioning laser (46) is designed as a cross laser which, when the bracket (18) is applied to the tooth front, can generate linear markings (28, 30) in an imaginary extension on the left and right (30) of the bracket slot (22) and orthogonally thereto upwards and downwards (28).

11. The instrument (10) according to claim 10, wherein a transition part (40) is provided between the head part (14) and the handle part (12), wherein the transition part (40) has at least four recesses (44) for the exit of the cross laser beams.

12. The instrument (10) according to claim 11, wherein the transition part (40) is designed to taper conically towards the head part (14).

13. The instrument (10) according to claim 9, wherein the cross laser (46) is arranged at the head-side end of the handle part (12).

14. The instrument (10) according to claim 9, wherein the positioning laser (46) is designed to emit blue and/or red and/or green light.

15. The instrument (10) according to claim 1, wherein the head part (14), optionally including or without the transition part (40), is designed to be exchangeable.
